(19) United States
(12) Patent Application Publication
(10) Pub. No.: US 2005/0060471 A1
(43) Pub. Date: Mar. 17, 2005

(54) Serial data interface system and method having bilingual functionality

(75) Inventors: Josephus A.E.P. van Engelen, Aliso Viejo, CA (US); Pieter Vorenkamp, Laguna Niguel, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation

(21) Appl. No.: 10/660,670

(22) Filed: Sep. 12, 2003

(51) Int. Cl. G06F 13/14

(52) U.S. Cl. 710/305

(57) ABSTRACT

A serial interface device has first and second transceivers complying with first and second standards (e.g., 1394-1995/1394a-2000 and IEEE 1394b-2002). The first and second transceivers can be formed as a single circuit. Alternatively, the first and second transceivers can be formed as separated circuits that are coupled to pairs of pins, through which signals are transmitted and received along first and second media pairs. In various embodiments, the separated first and second transceivers can be linked to or tied into the pins either inside or outside of a chip.

### BACKGROUND OF THE INVENTION

1. Field of the Invention

The present invention is related to Bilingual ports in IEEE1394 devices.

2. Background Art

Several specifications or standards have been implemented that specify requirements for FireWire (Apple), i.link (Sony), and IEEE1394. These standards were implemented in 1995 (IEEE1394-1995), 2000 (IEEE1394a-2000), and 2002 (IEEE1394b-2002). All the standards for IEEE1394 describe a general high speed serial interface or a serial bus for cable or backplane media to transmit and receive data traveling at about 25 Mbit/sec (Mbps) to about 2 Gbit/sec (2 Gbps), with higher speeds contemplated in the future. IEEE1394b is intended to provide mode media (e.g., optical media, UTP-5 cable, etc.) and higher data rates. The 1995 and 2000 standards are collectively referred to as Legacy or DS (data-strobe) and the 2002 standard is referred to as Beta. Conventional functionality and devices described in detail in the standards noted above are not repeated within this document, which are all incorporated by reference herein in their entireties. Included in the IEEE1394b-2002 is a bilingual mode, which requires a single port in PHY analog core to transmit and receive all Legacy and Beta signals.

Therefore, what is needed is a system and method for configuring a Bilingual port so that it can transmit and receive both Legacy and Beta signals.

### BRIEF SUMMARY OF THE INVENTION

The present invention is directed to methods and systems for transmitting and receiving Legacy and Beta signals between Bilingual ports.

An embodiment of the present invention provides a serial data interface system. The system includes a first transceiver configured to comply with a first standard (e.g., 1394-1995/1394a-2000) coupled to a set of pins and a second transceiver configured to comply with a second standard (e.g., IEEE 1394b-2002) coupled to the set of pins.

Another embodiment of the present invention provides a serial data interface system. The system includes a first section configured to comply with a first standard (e.g., 1394-1995/1394a-2000) and a second section configured to comply with a second standard (e.g., IEEE 1394b-2002). The first section includes a TPBIAS device section coupled to first and second pins (through additional external circuitry), a first transceiver section coupled to the first and second pins, and a second transceiver section coupled to the third and fourth pins. The second section includes a signal transmitting device coupled to the third and fourth pins and a signal receiving device coupled to first and second pins.

Embodiments of the present invention provide a method including (a) transmitting and receiving data in compliance with a first standard (e.g., IEEE 1394b-2002) on first and second differential media pairs, (b) transmitting data in compliance with a second standard (e.g., IEEE 1394b-2002) on the second differential media pair, (c) receiving data in compliance with second standard on the first differential media pair, and (d) switching use of the first and second differential media pairs between step (a) and steps (b) and (c). In one embodiment, steps (b) and (c) are done substantially simultaneously.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram of an IEEE1394 system according to embodiments of the present invention.

FIG. 2 is a block diagram of an IEEE1394 node in the system of FIG. 1.

FIG. 3 is a block diagram of an IEEE1394 PHY chip in the IEEE1394 node of FIGS. 1 and 2.

FIG. 4 shows a typical peer-to-peer connection scheme between Legacy and Beta ports.

FIG. 5 shows a Bilingual Port according to an embodiment of the present invention.

FIG. 6A shows a Bilingual Port according to another embodiment of the present invention.

FIG. 6B shows a Legacy device in the Bilingual port of FIG. 6A.

FIG. 6C shows a Beta device in the Bilingual port of FIG. 6A according to an embodiment of the present invention.

The present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION OF THE INVENTION

Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

Embodiments of the present invention provide a Bilingual port in a serial interface device having Legacy signal and Beta signal devices (e.g., 1394-1995/1394a-2000 and IEEE 1394b-2002 transceivers). In one embodiment, the Legacy and Beta signal devices can be formed as a single circuit. In another embodiment, Legacy and Beta signal devices are formed as separated circuits that are coupled to common pins, through which signals are transmitted and received along various media, such as twisted-wire pairs (TPs) (in the case of the “short-haul copper” cable media). It is to be appreciated that, although only an embodiment with TPs is discussed, other media can also be used, all of which are contemplated within the scope of the present invention. Using separated circuits to process Legacy and Beta signals in the Bilingual port may be much less complex and expensive than the first embodiment, in which a single circuit handles both Legacy and Beta signals.

It is to be appreciated that in various embodiments the separated Legacy and Beta signal circuits can linked to or tied into the pins either inside or outside of a chip.

Overview of IEEE 1394 System

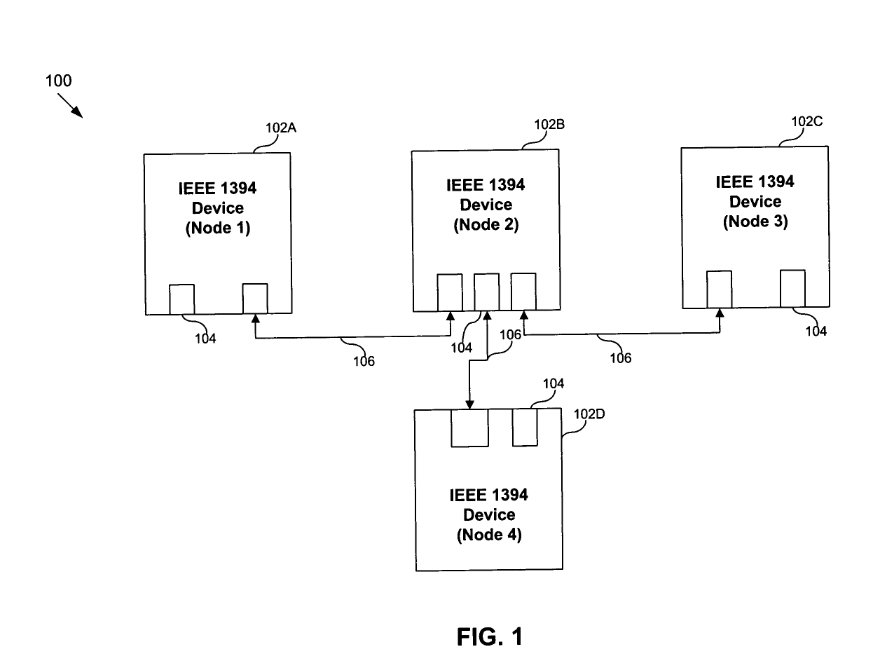

FIG. 1 is a block diagram of a section 100 of an IEEE 1394 system including a plurality of nodes 102 (e.g., 102A-102D) according to embodiments of the present invention. Up to 1000 systems 100 can be interconnected, and each system 100 can include, for example, up to 63 peers or nodes 102. Nodes 102 include one or more ports 104. Nodes 102 having multiple ports 104 behave as repeaters. Loops are generally not allowed, so all nodes 102 are connected in a tree structure via cables 106. Each cable 106 includes at least two twisted-wire pairs (TPs). Node-to-node (e.g., peer-to-peer) connections can be at various speeds and using various modes (e.g., Legacy or Beta). Arbitration is used to determine which node 102 can talk on a particular bus to another node. An algorithm is used to process requests from nodes 102 to determine which node 102 will talk on the bus at a particular time period.

Bus speeds or signaling speeds are based on multiples of a base speed S100 that is formed from multiples of 24.576 MHz. Base Legacy speed S100 is about 98.304 Mbps and base Beta speed S100 is about 122.88 Mbps. Every port 102 has to support lower speeds than its rated speed. For example, a Legacy S400 port must support Legacy S200 and Legacy S100.

Data transfer is packet based using either Isochronous (e.g., periodic, guaranteed bandwidth, usually video, audio, etc.) or Asynchronous (e.g., a-periodic, usually data transfer, etc.) packets. As discussed above, data can be sent over several media, which can include copper, glass, fiber, or other materials. The material used can depend on the data speed and/or the standard or mode of the signals (e.g., Legacy or Beta). The mode also dictates a number of pins (e.g., Legacy 4 or 6 and Beta 9) required for connectors coupled to either end of the cables 106 in the case of the ‘short-haul copper’ cable media.

Legacy signaling (e.g., data or strobe signals) is performed using half-duplex signaling. For example, a Legacy system has a TP bias (TPBIAS) system (e.g., for setting and controlling signal speed, common mode voltage, checking connections, and other functions) and first and second TPs. For half-duplex signaling, sending or receiving of signals is performed over both the first and second TPs, but does not send and receive at the same time.

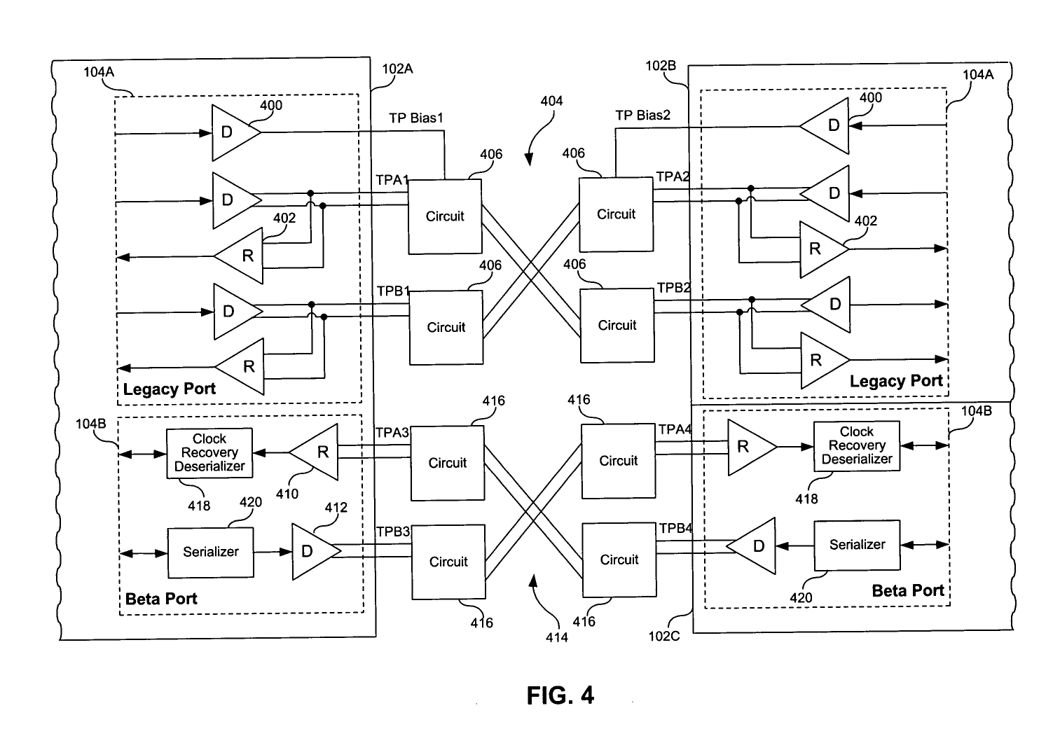

FIG. 4 shows a typical IEEE 1394 connection scheme for Legacy ports 104A and Beta ports 104B between nodes 102. Signals from the first and second TPs (e.g., TPA1 and TPB1) cross. For example, during transmitting, TPA1 at a first node 102A transmits a signal that is received by TPB2 at a second node 102B. Data traveling from a first node 102A along TPA1 is used by second node 102B along TPB2.

The data and strobe signals are differential binary signals. Mixed speed signals can be transmitted on the same wires. Arbitration is performed using DC-like line states (e.g., 1, 0, and Z where Z indicates high-impedance state) with no continuous clock recovery, and using asynchronous analog technology.

Beta signaling is usually performed with serializer/deserializer (SerDes) technology and using dual simplex signaling. For example, when TPs are used, a first TPB3,4 is used only to transmit from a serializer, and a second TPA3,4 is used only to receive at a deserializer. Idle, arbitration, and packet speed information is transmitted as symbols in the data, which can allow for continuous clock recovery. Toning is used to check for connection and signal speed.

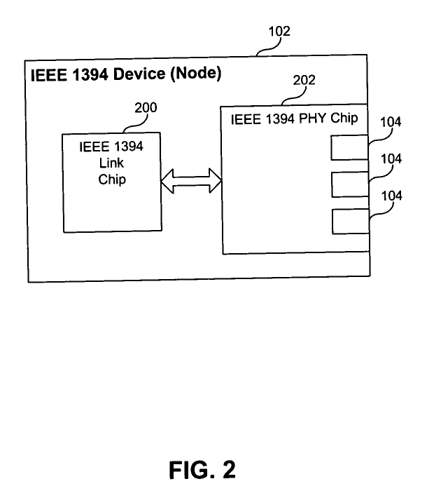

FIG. 2 is a block diagram of a node 102, including an IEEE1394 link chip 200, which performs similar function as a media access controller (MAC) in the IEEE802.3 (Ethernet) standard. The node 102 also includes an IEEE 1394 physical layer device (PHY) chip 202.

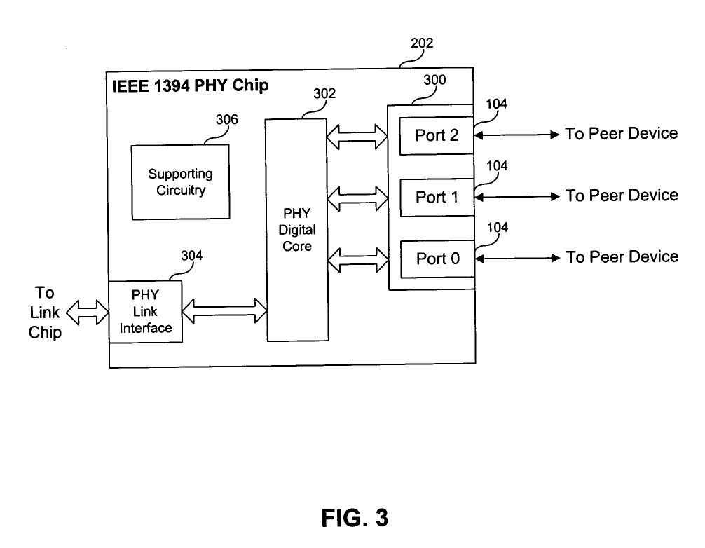

FIG. 3 is a block diagram of PHY chip 202. A PHY analog core 300 includes ports 104. A PHY digital core 302 processes all digital signals received and transmitted by port 104. A PHY/link interface 304 links PHY chip 202 to link chip 200. Supporting circuitry 306 is used to control, power, and couple these and other devices in PHY chip 202.

Returning to FIG. 4, Legacy ports 104A include drivers (D) 400 and receivers (R) 402 for directing Legacy signals. Legacy signals travel from TPA and TPB pins along TPA1,2 and TPB1,2 to and from ports 104A to connection systems 404 that include supporting circuitry 406. Signals from 102A and 102B are cross-connected using connection system 404 (e.g., TPA1 and TPB2 connect, while TPA2 and TPB1 connect). Doing this allows signals transmitted from a first node 102A along TPA1 to be received along TPB2 at node 102B.

Beta ports 104B include standard-based receivers (R) 410 and drivers (D) 412 for directing Beta signals. Beta signals are always received along TPA3,4 and always transmitted along TPB3,4 using connection system 414 having supporting circuitry 416. Devices 418 perform clock recovery and deserialization on received signals. Transmitted signals are serialized and transmitted using device 412 and 420 before being transmitted.

Part of the 2002 standard is a bilingual mode, which requires a single port 104 in PHY analog core 300 to transmit and receive all Legacy and Beta signals. For example, PHY analog core 300 could include a Legacy port 104A, a Beta port 104B, and Bilingual port 104C.

Bilingual Port Having a Combined Legacy and Beta System

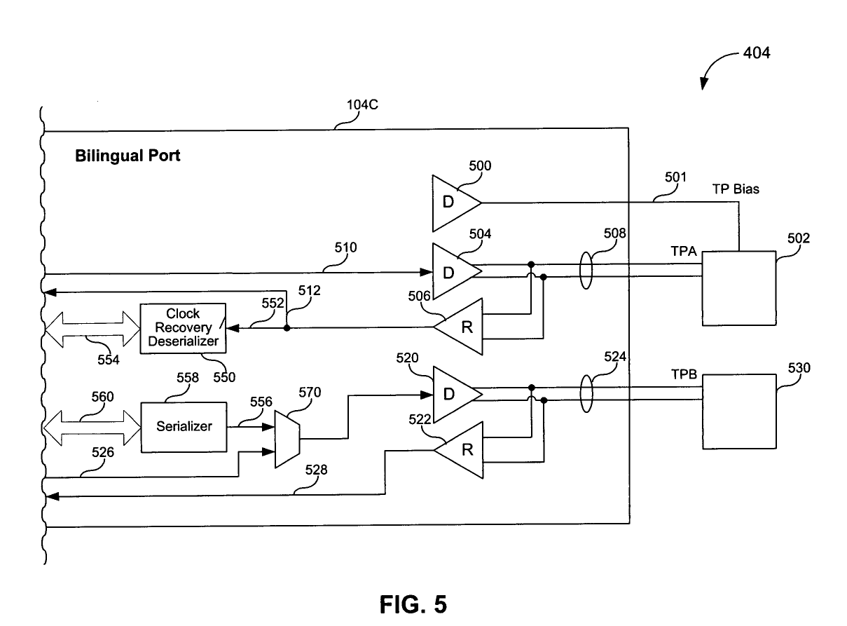

FIG. 5 shows a Bilingual port 104C having a combined Legacy and Beta system

In this example, a Legacy signal section includes a TP Bias driver 500, which transmits a signal along TPBIAS path 501 to circuitry 502 in connection system 404. A transmit driver 504 and receiver 506 are coupled to TPA 508. TPA 508 is used to transmit signals 510 and receive signals 512 between circuitry 502 and PHY digital core 302 (FIG. 3). Similarly, a transmit driver 520 and receiver 522 are coupled to TPB 524. TPB 524 is used to transmit signals 526 and receive signals 528 between circuitry 530 in connection system 404 and PHY digital core 302.

With continuing reference to FIG. 5, a Beta signal section includes a clock and data recovery (CDR) and deserializer system 550. System 550 receives signals 552 transmitted along TPA 508 from circuitry 502 via receiver 506. System 550 recovers a clock signal from signals 552. The recovered clock signal is used during deserializing of signals 552. Deserialized signals are transmitted to PHY digital core 302 via an interface device 554. The Beta signal section also includes a serializer 558 that receives signals via interface device 560 from PHY digital core 302. Serialized signals 556 are transmitted via driver 520 along TPB 524 to circuitry 530.

Control circuits and devices (not fully shown) are used to switch Bilingual port 104C between Legacy and Beta modes, depending on signals being transmitted or received. Multiplexer 570 is part of the control circuitry, and is used to control which transmit signals 526 (e.g., Legacy mode) or 556 (e.g., Beta mode) will be received at driver 520. Depending on the mode of the signals being transmitted and/or received, different devices within Bilingual port 104C will be active or in-active.

For example, when node 102 determines Legacy signals are being received, a Legacy mode is set in the Bilingual port 104C. Receivers 506 and 522 receive signals 512 and 528 from TPA 508 and TPB 524, respectively. These signals are directed to PHY digital core 302. Similarly, in Legacy mode, drivers 504 and 520 (the latter via multiplexer 570) transmit signals 510 and 526 from PHY digital core 302 out TPA 508 and TPB 524.

Similarly, when node 102 determines Beta signals are being transmitted and received, a Beta mode is set in the Bilingual port 104C. During reception, receiver 506 receives signals 552 from TPA 508. Signals 552 are deserialized using system 550 under control of a clock that is recovered from signals 552. The deserialized signals are directed to PHY digital core 302 via interface 554. During transmission, serializer 558 generates serial signals 556 based on signals received via interface 560 from PHY digital core 302. Then, serialized signals 556 are transmitted along TPB 524 using driver 520.

There are several parameters to be considered when implementing the Bilingual port 104C. These parameters include: (a) TP usage, (b) arbitration and data signaling technology, (c) signal amplitude criteria, (d) signal rise and fall time (e.g., a transition time between HIGH and LOW of each signal) criteria, (e) common-mode biasing technology, and (f) speed and connection signaling and detection.

TP Usage

Beta data rates are typically higher than legacy data rates. Thus, TPA 508 and TPB 524 should be manufactured from materials, and use related circuitry, that can handle Beta mode speeds.

Arbitration and Data Signaling Technology

In Legacy mode, an arbitration signal is an asynchronous, DC-like type of signal and data packets include synchronous signals. Arbitration and data signals are sent alternately, so incoming signals change from synchronous to asynchronous. Thus, a Legacy port cannot perform clock recovery because clock information would be lost during arbitration. In contrast to Legacy mode, in Beta mode symbols or specific types of data are sent to indicate arbitration. Arbitration, speed and data packets are sent at a fixed signaling rate without interruption, allowing clock recovery to be performed. Then, the recovered clock signal is used to deserialize the data.

Signal Amplitude and Rise/Fall Times

Beta and Legacy modes have divergent signal amplitude and signal rise/fall time criteria. In Legacy mode, a differential signal amplitude should be between 172 mV and 265 mV and minimum rise/fall times (10%-90%) should be about 500 ps. In contrast, during Beta mode, a differential signal amplitude should be between about 350 mV and 800 mV and maximum (10%-90%) rise fall times are about 400 ps, when using a S800 signal.

Common-mode Biasing

In Legacy mode, each signal pair is common-mode biased using the TPBIAS signal from a first port 104 through a common-mode resistive load at the TPB side of a second port 104. In contrast, during Beta mode, TPBIAS should be inactive and biasing is provided at the individual ports.

Speed and Connection Detection

In Legacy mode, common mode voltage changes are detected in order to determine connection status and speed of data being transmitted. Each packet can have a different data speed, and a receiving node has to be informed of the incoming data speed. In contrast, in Beta mode, all data packets are sent at a same signaling speed, which cannot be changed between packets. Also, connection status and signaling speed are determined using tone signals having HIGH and LOW patterns, which are received before packet transfers take place.

Bilingual Port Having Separated Legacy and Beta Devices Coupled to Common Pins

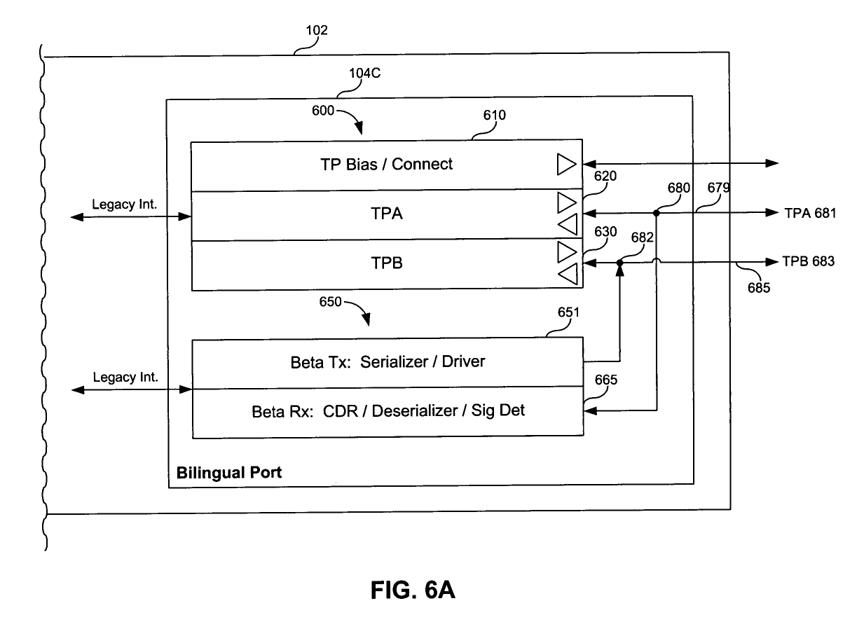

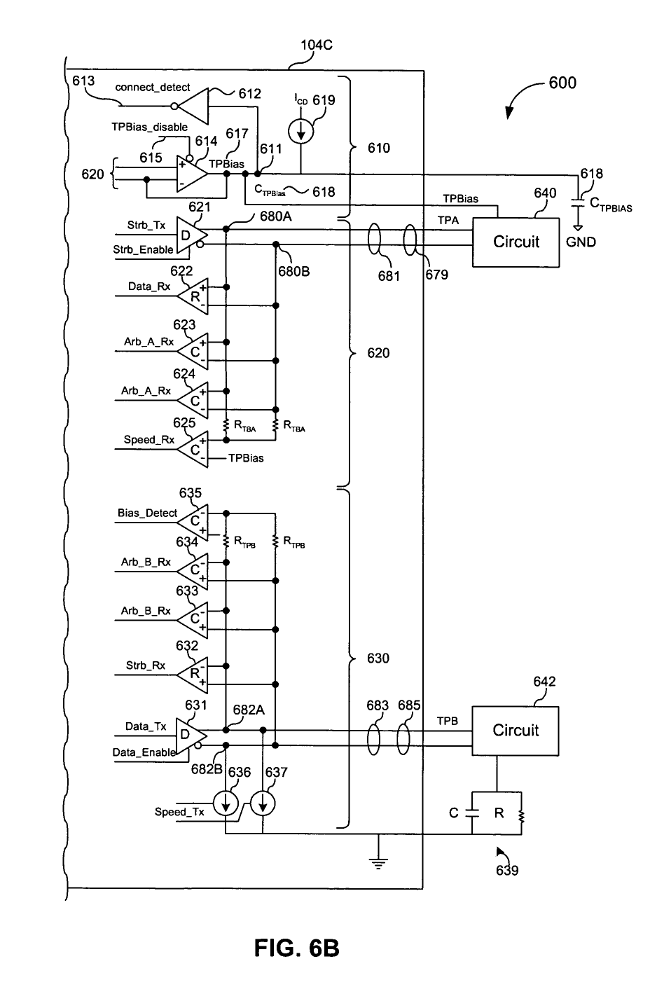

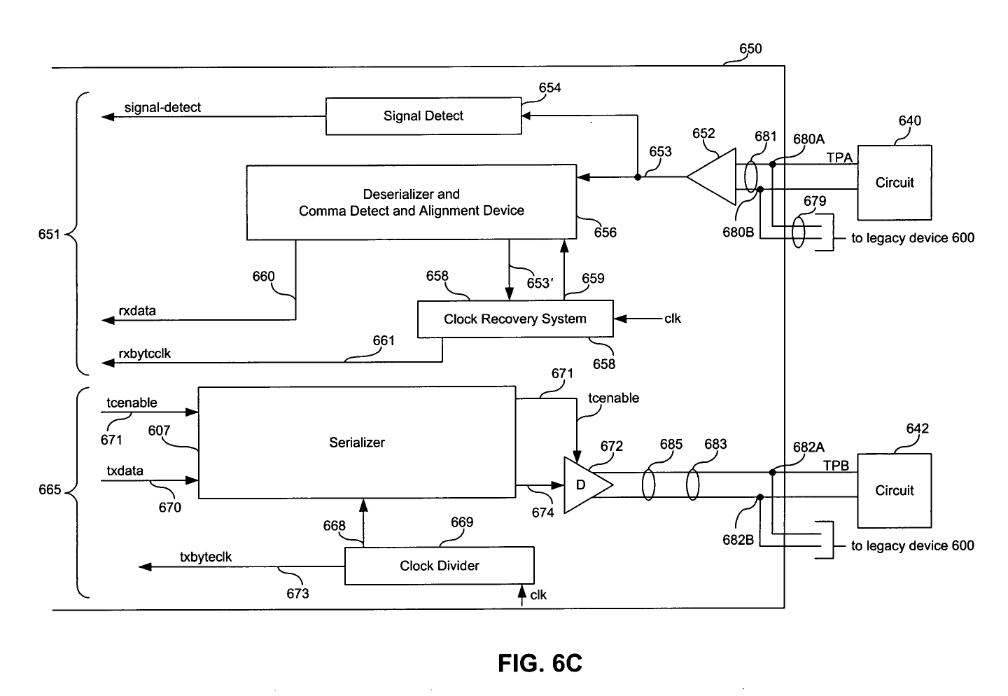

FIG. 6A shows a Bilingual port 104C having Legacy and Beta signal devices 600 and 650, respectively, coupled at common differential signal pin 680 (e.g., 680A and 680B, a pair of pins) and differential signal pin 682 (e.g., 682A and 682B, a pair of pins), respectively, according to embodiments of the present invention. A differential signal 679 is transmitted and received at pins 680A and 680B connected to TPA 681 and a differential signal 685 is transmitted and received at pins 682A and 682B connected to TPB 683. Based on what type of signals (e.g., Legacy or Beta signals) are being sent and received, Bilingual port 104C activates either the Legacy device 600 or the Beta device 650. Although not shown, in an alternative embodiment Beta signal device 650 can also be coupled to TPBIAS, which is contemplated within the scope of the present invention.

Legacy signal device 600 includes a TPBIAS/Connect device 610, a first transceiver device 620, and a second transceiver device 630. An IEEE1394-1995/2000 standard example of Legacy signal device 600 is shown in FIG. 6B. A full description of the elements discussed below and their functionality is found in these standards, which are incorporated by reference herein in their entireties.

In the example of FIG. 6B, TPBIAS/Connect device 610 includes a driver 612 coupled between a node 611 and PHY digital core 302. Driver 612 outputs a Connect_Detect signal 613 to PHY digital core 302 when connection to another node 102 is detected. A driver 614 is coupled between PHY digital core 302 and node 611. Driver 614 receives a TPBIAS_Disable signal 615 at its control terminal, signals 616 from PHY digital core 302 at its input terminals, and outputs a TPBIAS signal 617. A capacitance C_{TPBIAS} (e.g., about 0.3 uF) 618 is coupled in between node 611 and ground (GND). Node 611 receives a current signal from a current source I_{CD} 619.

First transceiver 620 includes a driver 621 that outputs a Strb_Tx signal under control of a Strb_Enable signal. The Strb_Tx signal is transmitted from pin 680 via common differential signal 679 along TPA 681 to circuitry 640. In the example of FIG. 6B, common differential signal 679 is transmitted from pins 680A and 680B.

First transceiver 620 also includes receiver 622 and comparators 623, 624, and 625. Receiver 622 and comparators 623 and 624 have their non-inverting inputs coupled to TPA 681 via pin 680B and their inverting inputs coupled to TPA 681 via pin 680A. Comparator 625 receives the TPBIAS signal at its inverting input and is coupled at its non-inverting input through resistors R_{TPA} (e.g, 7 k Ohms resistors) to TPA 681 via pins 680A and 680B. Receiver 622 passes a Data_Rx signal. Comparators 623 and 624 generate Arb_A_Rx signals. Comparator 625 generates Speed_Rx signals. All of the generated signals are transmitted to the PHY digital core 302.

Second transceiver 630 includes a driver 631 that outputs a Data_Tx signal under control of a Data_Enable signal. The Data_Tx signal is transmitted from pins 682A and 682B via differential signal 685 along TPB 683 to circuitry 642. Second transceiver 630 also includes receiver 632 and comparators 633, 634, and 635. Receiver 632 and comparators 633 and 634 have their non-inverting inputs coupled to TPB 683 via pin 682B and their inverting inputs coupled to TPB 683 via pin 682A. Comparator 635 receives a voltage signal (e.g., 0.8V) at its non-inverting input. The inverting input of comparator 635 is coupled through resistors R_{TPB} (e.g, about 7 k Ohm resistors) TPB 683 via pins 682A and 682B. Receiver 632 passes a Strb_Rx signal. Comparators 633 and 634 generate Arb_B_Rx signals. Comparator 635 generates a Bias_Detect signal. All of the generated signals are transmitted to the PHY digital core 302. TPB device 630 also includes two current sources 636 and 637 controlled by Speed_Tx signals. Current source 636 is connected between circuit 642, via an RC circuit 639 to TPB 683 via pin 682B. Current source 637 is connected between circuit 642, via the RC circuit 639, to TPB 683 via pin 682A.

FIG. 6C is a block diagram of a Beta signal device 650 according to embodiments of the present invention. Beta signal device 650 includes a receiving section 651 coupled to TPA 681 and a transmitting section 665 coupled to TPB 683.

Beta signal receiving section 651 includes a receiver 652 that directs data 653 to a Signal Detect device 654 and Deserializer and Comma Detect and Align device 656 (hereinafter “deserializer system”). Signal Detect device 654 outputs a signal_detect signal to PHY digital core 302 indicative of receipt of data 653 or a tone. Data 653 is directed to a deserializer system 656 (e.g., which can include a 1-to-N deserializer, N being an integer, equal to or greater than 2) and data 653′ that has been processed in a portion of deserializer system 656 is directed to a clock recovery system 658. Clock recovery system 658 also may receive a clock signal CLK. Clock recovery system 658 can use a phase-locked loop containing for example: one or more phase detectors, a loop filter, a VCO or phase interpolator, etc, to recover a clock associated with data signal 653′. Clock recovery system 658 generates the recovered clock signal 659 that is fed back to deserializer system 656. After data 653 is deserialized, comma detect and alignment is performed in a portion of deserializer system 656. The portion of deserializer system 656 performing comma detect and alignment transmits an rxdata signal 660 to PHY digital core 302. Clock recovery system 658 transmits a rxbytcclk signal 661 to PHY digital core 302.

Beta signal transmitting section 665 includes a serializer system (e.g., which can include at least a N-to-1 serializer, N being an integer, equal to or greater than 2) 667 that receives a txdata signal 670 from PHY digital core 302. Serializer system 667 is driven using a clock signal 668 from Clock Divider 669. Clock Divider 669 is driven using clock signal CLK. Clock Divider 669 also outputs a txbyteclk signal 673 to PHY digital core 302. A tcenable signal 671 from PHY digital core 302 passes through serializer system 667 before being received at driver 672. If tcenable activates driver 672, a serialized signal 674 is transmitted through common pins 682 along TPB 683 to circuitry 642. Transmitter 672 can also send a tone signal along TPB 683 to circuit 642. As discussed above, the tone signal can be used to transmit data speed and determine connection status.

It is to be appreciated that, although Legacy signal device 600 and Beta signal device 650 are shown as being tied into or linked to TBA 681 and TPB 683 through common pins 680 and pins 682 inside PHY analog device 300, they could be linked or tied to pins 680 and 682 outside PHY analog device 300 or outside node 102, as would be known to a skilled artisan.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A serial data interface system comprising:
a first transceiver configured to comply with a first standard coupled to a set of pins; and
a second transceiver configured to comply with a second standard coupled to the set of pins.

2. The system of claim 1, wherein:
the first standard is IEEE 1394-1995/1394a-2000 standard; and
the second standard is IEEE 1394b-2002 standard.

3. The system of claim 1, wherein the first transceiver device comprises:
a twisted-wire pair (TP) bias section;
a first TP transceiver section; and
a second TP transceiver section

4. The system of claim 3, wherein the TP bias section comprises:
a TP bias device; and
a connection detection device

5. The system of claim 3, wherein the first TP transceiver section comprises:
a strobe signal device;
a data signal device;
an arbitration signal device; and
a speed detection device.

6. The system of claim 5, wherein at least one of the strobe signal, data signal, arbitration signal, and speed detection devices is an asynchronous device.

7. The system of claim 3, wherein the second TP transceiver section comprises:
a strobe signal device;
a data signal device;
an arbitration signal device; and
a bias signal detection device.

8. The system of claim 7, wherein at least one of the strobe signal, data signal, arbitration signal, and bias signal detection devices is an asynchronous device.

9. The system of claim 1, wherein the second transceiver comprises:
a transmitter section coupled to the second pin; and
a receiver section coupled to the first pin.

10. The system of claim 9, wherein the transmitter section comprises:
a clock;
a serializer; and
a driver.

11. The system of claim 10, wherein the serializer comprises a N to 1 serializer, wherein N is an integer equal or larger than 2

12. The system of claim 9, wherein the receiver section comprises:
a clock recovery system;
a deserializer;
a comma detect and alignment device; and
a signal detect device.

13. The system of claim 12, wherein the deserializer comprises a 1-to-N deserializer, wherein N is an integer number equal to or larger than 2.

14. The system of claim 12, wherein the clock recovery system comprises:
a phase detector;
a loop filter; and
a phase interpolator.

15. A serial data interface system, comprising:
a first section configured to comply with a first standard including,
a TPBIAS device section coupled to first and second pins (through additional circuitry),
a first transceiver section coupled to the first and second pins, and
a second transceiver section coupled to the third and fourth pins, and
a second section configured to comply with a second standard including,
a signal transmitting device coupled to the third and fourth pins, and
a signal receiving device coupled to the first and second pins.

16. The system of claim 15, wherein:
the first standard is IEEE 1394-1995/1394a-2000 standard; and
the second standard is IEEE 1394b-2002 standard.

17. A serial data interface system, comprising:
first and second pair of pins;
a bias pin;
a first transceiver including first and second transceiver modules, said first transceiver module coupled to said first pair of pins, said second transceiver module coupled to said second pair of pins; and
a second transceiver including a transceiver module coupled to said second pair of pins and a receiver module coupled to said first pair of pins.

18. A method comprising:
(a) transmitting and receiving data in compliance with a first standard on first and second differential media pairs;
(b) transmitting data in compliance with a second standard on the first differential media pair;
(c) receiving data in compliance with the second standard on the second differential media pair; and
(d) switching use of the first and second differential media pair between step (a) and steps (b) and (c).

19. The method of claim 18, wherein steps (b) and (c) are performed substantially simultaneously.

20. The method of claim of claim 18, further comprising:
using IEEE 1394-1995/1394a-2000 as the first standard; and
using IEEE 1394b-2002 as the second standard.

21. The system of claim 1, wherein the first transceiver comprises:
a bias section;
a first transceiver section; and
a second transceiver section.

22. The system of claim 21, wherein the bias section comprises:
a bias device; and
a connection detection device.

23. The system of claim 21, wherein the second transceiver section comprises:
a strobe signal device;
a data signal device;
an arbitration signal device; and
a bias signal detection device.

24. The system of claim 23, wherein at least one of the strobe signal, data signal, arbitration signal, and bias signal detection devices is an asynchronous device.
